(19) United States
(12) Patent Application Publication
(10) Pub. No.: US 2023/0241988 A1
(43) Pub. Date: Aug. 3, 2023

(54) VEHICLE UNIT, GROUND UNIT AND METHOD FOR CHARGING A BATTERY OF AN ELECTRIC VEHICLE

(71) Applicant: WEBASTO SE, Stockdorf (DE)

(72) Inventors: Thomas PODOLSKI, Stockdorf (DE); Harald BACHMANN, Stockdorf (DE)

(21) Appl. No.: 18/003,288

(22) PCT Filed: Jun. 24, 2021
(86) PCT No.: PCT/EP2021/067384

§ 371 Date: Dec. 23, 2022

(30) Foreign Application Priority Data
Jun. 24, 2020 (DE) 10 2020 116 623.0

(51) Int. Cl. B60L 53/16; B60L 53/35; H01R 13/71; H01R 13/52

(52) U.S. Cl. CPC B60L 53/16; B60L 53/35; H01R 13/71; H01R 13/5213; H01R 2201/26; H01R 2107/00

(57) ABSTRACT

A vehicle unit for charging a battery of an electric vehicle including a receptacle, which is designed and configured to receive a contact head, inserted in an insertion direction of a floor unit, and contact elements for establishing an electrical connection with contacts of the contact head, wherein the contact elements can be moved in a plane perpendicular to the insertion direction for the purpose of establishing the electrical connection with the contact head.

### CROSS REFERENCE TO RELATED APPLICATIONS

This application is a national stage of International Application No. PCT/EP2021/067384 filed Jun. 24, 2021, which claims priority from German Patent Application 10 2020 116 623.0 filed Jun. 24, 2020 in the German Patent and Trademark Office, the disclosures of which are incorporated herein by reference in their entirety.

### BACKGROUND

### Technical Area

The present invention relates to a charging device for charging a battery of an electric vehicle, in particular for charging a traction battery of a motor vehicle driven by an electric motor, for example a vehicle driven exclusively by an electric motor or a plugin hybrid vehicle, in particular for automatically connecting the electric vehicle to the charging infrastructure for the purpose of automatically charging this traction battery.

### RELATED ART

Purely electric vehicles or also hybrid vehicles, which have both an internal combustion engine and an electric motor as the drive, are equipped with a traction battery. Energy for driving the respective electric motor, and therefore for moving the vehicle, is stored in the traction battery. For external charging of such a traction battery, it is known to connect the electric vehicle or a plugin hybrid vehicle to an external charging infrastructure via a charging cable. In this case, for example, a connection to a power source in the form of a wall box, charging column etc. is established and the actual charging procedure is then started.

The connection of the charging cable to a charging socket arranged on the electric vehicle is realized manually. Manual connection of a charging cable to a charging socket on the electric vehicle is awkward, so various options for automatic charging are proposed, which no longer require the plug arranged on a charging cable to be manually inserted into the charging socket. For example, the charging of the electric vehicle may take place inductively, i.e. without cables. However, since inductive charging methods are subject to high losses, this method is only attractive under restricted conditions.

It has therefore been proposed that an electrical connection between the power source and the electric vehicle be established by inserting a plug into the charging socket by means of a robot arm. It should be noted in this case that charging sockets for establishing a manual connection are usually arranged on the side, front or rear of the electric vehicle so that they can be easily reached by the respective user. However, to establish the connection automatically, it has moreover also been proposed that the charging socket be placed in the region of the roof or in the underbody of the electric vehicle.

Placing the charging socket in the underbody of the electric vehicle seems particularly advantageous since the floor unit with the power connection may be arranged in the floor such that it is possible to drive over it, e.g. in a parking space or in a garage, so that the electric vehicle may park above the floor unit. The electrical connection is then established automatically by means of a robot arm, which is arranged on the floor and connected to the power source, or a lifting device. This is space-saving and practical since there is no cable or robot arm preventing free access around the vehicle during charging.

In the known systems for automatic charging by means of charging sockets arranged in the underbody of the electric vehicle, however, the electrical contacts of the charging socket are open towards the floor in a vertical direction. Contacting therefore takes place in the vertical direction. In this case, the contacts of the floor unit and the contacts of the charging socket in the vehicle unit are subject to mechanical damage as a result of road stones, contamination and spray water.

In DE 102014200290 A1, a charging device for automatic charging of an electric vehicle is disclosed, wherein the vehicle unit has a displaceable connection device with downwardly aligned contact elements which can be contacted from below via a lifting device.

Likewise, in WO 18055498 A2, a displaceable connection device is provided in the vehicle unit. Moreover, contact elements are arranged concentrically on the contact head of the floor unit.

In DE 102014226357 A1, a device for automatically charging an electric vehicle by means of a charging robot is disclosed. The charging robot comprises a contact head having circular depressions in which an electrical contact may be arranged in each case, whereby the contact head is designed to be rotationally symmetrical. The depressions in the contact head may also be designed as circular segments. A plurality of contacts may thus be arranged within a circle circumference.

In WO16119001 A1, a plug connection for connecting electrical lines, consisting of a male connecting element and a female connecting element, which can be releasably connected to one another with force fit, is disclosed. The contacts of the male connecting element are formed coaxially and are displaceable so that they are arranged within the male connecting element in a first position and project out of the male connecting element in a second position.

### SUMMARY

An improved device for charging an electric vehicle, and a corresponding method are described herein according to various embodiments.

A vehicle unit for charging a battery of an electric vehicle is therefore proposed, comprising a receptacle, which is designed and configured for receiving a contact head, inserted in an insertion direction, of a floor unit, and contact elements for establishing an electrical connection with contacts of the contact head, wherein the contact elements can be moved in a plane perpendicular to the insertion direction for the purpose of establishing the electrical connection with the contact head.

In other words, the vehicle unit is designed such that, to charge a battery of an electric vehicle, a contact head of a floor unit is firstly inserted into the vehicle unit in an insertion direction. Contact elements of the vehicle unit are then moved towards the contact head, whereby contacting takes place between the contact elements and the contacts on the contact head. The movement of the contact elements is realized in a plane perpendicular to the insertion direction of the contact head.

As a result of this connection of the contact head in a plane perpendicular to the insertion direction, it may be achieved that the contacts on the contact head likewise extend in a plane perpendicular to the insertion direction, or are freely accessible from the side of the contact head. The contacts are therefore particularly protected and, in contrast to the prior art, the contacting does not have to be achieved via a vertical contact pressure between a contact head and corresponding mating contacts. Instead, particularly reliable contacting may be achieved as a result of the quasi radial contacting, which results in the contacts being clasped on one side, two sides or more sides.

For a vehicle unit in the underbody of the electric vehicle, the plane perpendicular to the insertion direction is, at the same time, also the plane parallel to the underbody of the vehicle.

The electric vehicle may in some embodiments be a motor vehicle with a purely electric drive or a plugin hybrid vehicle, in which the energy required for the electric driving operation is stored in a battery, also referred to as a traction battery, of the electric vehicle.

To enable a movement of the contact elements simultaneously, at least one contact element is in several embodiments arranged on a contact arm and the contact arm is configured and designed such that a movement of the contact arm results in a movement of the contact element into the receptacle, or out of it, in a plane perpendicular to the insertion direction of the contact head.

In this case, the contact arms may be arranged to be movable in a plane perpendicular to the insertion direction, e.g. in the underbody of the electric vehicle and parallel to this underbody. An arrangement of the contact arms in a plane parallel to the insertion direction is also possible, as is an arrangement of the contact arms in any other alignment. The movement of the contact arms may be translatory or rotational. Irrespective of the alignment and movement of the contact arms, the contact between the contacts on the contact head and the contact elements is always realized in a plane perpendicular to the insertion direction of the contact head.

In an embodiment, a first contact arm and a second contact arm are provided, on which a plurality of contact elements, for example three contact elements, are arranged in each case.

The number of contact elements on each contact arm may be smaller or greater than three. An asymmetrical distribution of the contact elements on the first and second contact arm is likewise possible. The total required number of contacts of the vehicle unit is dependent on the type of charging method, charging power etc.; for example, whether the charging is carried out with a single-phase or three-phase AC voltage or with a DC voltage or a combination thereof.

Data may also be transmitted as a result of the contacting, in order to enable communication between the vehicle and a charging control.

In one development, the first contact arm and the second contact arm are connected to one another by means of a kinematic system, for example by means of a rotational closure kinematic system, wherein the kinematic system enables the contact elements to move into and out of the receptacle of the vehicle unit.

In a configuration of the kinematic system as a rotational closure kinematic system, for example, a symmetrical formation of the contact arms is enabled, thereby ensuring that all contact elements contact the contact head symmetrically and at the same time. Particularly reliable contacting may thus be achieved, since the contact arms then execute a clasping movement, for example, which may also compensate a possible deviation between the position of the contact head and the intended position.

The vehicle unit is in certain embodiments installed in the underbody of the electric vehicle and the contact arms clasp the contact head from above, i.e. in a plane perpendicular to the underbody of the vehicle or from the side, i.e. in a plane parallel to the underbody of the vehicle—depending on the respective insertion direction of the contact head.

In the case of a vehicle unit in the underbody of the electric vehicle, the contact head is in various embodiments inserted into the vehicle unit from below in a direction perpendicular to the underbody. Since the contacts are freely accessible at the side of the contact head and are not aligned upwards, better protection of the contacts against contamination is achieved since water, snow and slush falling from the underbody cannot reach the contacts directly during the contacting operation.

In one configuration, the receptacle is defined by a housing, which has at least one cutout, in particular two cutouts, through which the contact elements may pass for the purpose of establishing the electrical connection with the contacts of the contact head.

The contact elements are thus well protected against contamination and mechanical damage, since they are located inside the vehicle unit when not in operation and are only moved into the receptacle during charging. Furthermore, only the contact elements move into the receptacle, which means that the other components of the vehicle unit are well protected with respect to the environment.

A centering device, for example a pin, is in various embodiments placed in the receptacle for the purpose of positioning the contact head, wherein the centering device, for example the pin, in several embodiments extends in the insertion direction. The centering device, for example the pin, prevents a translatory movement of the contact head in the plane perpendicular to the insertion direction. Precise and symmetrical contacting is thereby ensured.

The receptacle is in some embodiments designed to be substantially rotationally symmetrical, for example cylindrical, wherein the axis of symmetry, in one embodiment the cylinder axis, extends in the insertion direction. A rotationally symmetrical design may thus be achieved, which results in good flexibility with regard to the orientation of the contact head during its insertion.

A cover is in one or more embodiments provided for covering the receptacle, wherein the cover is in some embodiments designed as a flap with a pivot axis. Even better protection for the contact elements may thus be achieved, thereby enabling the construction of a robust and durable vehicle unit.

The cover in certain embodiments has at least one, for example two, locking hooks, which, when the cover is closed, may be locked by means of the kinematic system via a securing element arranged on a contact arm. Reliable locking, and also a greater sealing contact pressure of the cover, may thus be achieved in order to reliably ensure a weather-proof cover.

In a further configuration, an alternative or additional cover is provided, by means of which the at least one cutout, which is defined in the receptacle of the housing in order to enable the contact elements to pass through, may be covered. Reliable protection of the contact elements may thus be achieved.

The provision of an additional cover on the at least one cutout may moreover achieve that the contact elements are never exposed in an unprotected manner, since they are either protected by the additional cover or by the inserted contact head. In this case, to establish the connection, the first cover, by means of which the receptacle is closed, may therefore be opened and the contact head may then be inserted into the receptacle. Once the contact head has been inserted into the receptacle, the cover which covers the cutouts is then opened in order to thus enable the contact elements to pass into the receptacle. Full touch protection for the contact elements is thereby realized and the operational safety may be further increased.

A floor unit having a contact head, arranged on a lifting device, for example on a robot arm, for the purpose of charging a battery of an electric vehicle is therefore proposed, wherein the contact head can be inserted into a receptacle of a vehicle unit in an insertion direction and has contacts which are provided for establishing an electrical connection with contact elements of the vehicle unit. According to the present disclosure, the contacts of the contact head are designed and configured such that they can be contacted in a plane perpendicular to the insertion direction.

A floor unit matching the vehicle unit may thus be provided, in which the contacting of the contact head perpendicularly to the insertion direction enables a particularly robust configuration to be achieved, in which the contacts are well protected against external influences. In particular, as a result of arranging the contacts in positions which are perpendicular to the insertion direction, it may be achieved that contamination or collisions in the insertion direction do not have an effect on the contacts.

In one embodiment, the contact head is designed to be rotationally symmetrical, for example cylindrical, and the axis of symmetry, for example the cylinder axis, extends in the insertion direction. A rotationally symmetrical connection of the contact head in the vehicle unit may thus be ensured, so that there is no need for stringent demands with regard to the rotational positioning of the contact head. In additional to a cylindrical configuration, a conical configuration of the contact head may also be provided, for example. Further rotationally symmetrical configurations are conceivable.

The contacts of the contact head are in various embodiments arranged one above another in the insertion direction in the lateral surface of the rotationally symmetrical contact head, for example in the cylinder lateral surface, wherein three or six contacts are in certain embodiments arranged in the form of a ring, one above another. In the arrangement in the lateral surface of the rotationally symmetrical contact head, for example in the cylinder lateral surface, the contacts may also be offset inwards in grooves, so that particular protection may be achieved in the insertion direction.

The contacts may in one or more embodiments also extend in only half of the lateral surface of the rotationally symmetrical contact head, for example the cylinder lateral surface, in each case, wherein the contacts in various embodiments each extend in a circular segment which is smaller than 180 degrees and in several greater than 90 degrees and is in an exemplary embodiment 150 degrees. It is thus possible to form at least two different contacts for each ring.

In alternative configurations, more than two circular segments may also be provided or the contacts may also extend around the entire lateral surface.

In an alternative embodiment, the contact head may be designed as a horizontal cylinder, wherein the contacts of the contact head then extend coaxially and are open at the side so that they can be electrically connected to the contact elements of the vehicle unit from the side.

In a further embodiment, the contact head is designed to be rotationally symmetrical, for example cylindrical, wherein, on each half of the contact head around the vertical axis, a plurality of contacts, for example three contacts, are arranged concentrically one above another in order to ensure a connection of the contact head in the vehicle unit in a plane perpendicular to the insertion direction. This embodiment of the contact head corresponds to the above-described vehicle unit having two symmetrically arranged contact arms, each with three contact elements.

A method for automatic charging is furthermore proposed, wherein the method comprises the steps of providing a vehicle unit, which is mounted in the underbody of the electric vehicle and has a receptacle and movable contact elements, and providing a floor unit having a contact head. Furthermore, according to the method, the contact head of the floor unit is inserted into the receptacle of the vehicle unit in an insertion direction and the contact elements are moved in a plane perpendicular to the insertion direction in order to establish an electrical connection between the contact head and the vehicle unit.

### BRIEF DESCRIPTION OF THE FIGURES

Further embodiments of the invention are explained in more detail in the following description of the figures.

FIG. 1 shows a schematic perspective view of a vehicle unit from below, with a cover in a closed position;

FIG. 2 shows a schematic perspective illustration of the vehicle unit of FIG. 1, in which the cover is shown in an open position;

FIG. 3 shows a schematic perspective illustration of contact arms for contacting a contact head which can be received between them, wherein a surrounding housing has been omitted in the illustration;

FIG. 4a shows a schematic perspective illustration of the contact arms in an open position;

FIG. 4b shows a schematic perspective illustration of the contact arms in a closed position;

FIG. 5a shows a schematic plan view of the contact arms in an open position, in which insertion of a contact head is enabled;

FIG. 5b shows a schematic plan view of the contact arms in a closed position;

FIG. 6 shows a schematic perspective illustration of a contact head of a floor unit, which can be received in a receptacle of the vehicle unit, wherein the contacts of the contact head can be contacted by means of the contact arms of the vehicle unit;

FIG. 7 shows a schematic perspective illustration of a portion of a robot arm of the floor unit, wherein the robot arm carries the contact head;

FIG. 8 shows a schematic perspective illustration of the charging device from below, wherein the robot arm, carrying the contact head, of the floor unit has inserted the contact head into the open receptacle of the vehicle unit and the floor unit is therefore connected to the vehicle unit;

FIG. 9a shows a schematic perspective illustration of the contact arms and the contact head in an open position;

FIG. 9b shows a schematic perspective illustration of the contact arms and the contact head in a closed position, in which contacting of the contacts of the contact head by the contacts of the contact arms is established;

FIG. 10a shows a schematic side view of the contact arms and the contact head in an open position;

FIG. 10b shows a schematic side view of the contact arms and the contact head in a closed position;

FIG. 11 shows a schematic perspective illustration of a contact head in a further embodiment with six contacts, arranged one above another, and a corresponding contact arm; and

FIG. 12 shows a schematic perspective illustration of a contact head in a further embodiment in the form of a horizontal cylinder and a corresponding contact arm.

### DETAILED DESCRIPTION

Exemplary embodiments are described below with the aid of the figures. In this case, the same or similar elements or elements with the same effect are denoted by identical reference signs in the different figures and repeated description of these elements is sometimes omitted in order to avoid redundancy.

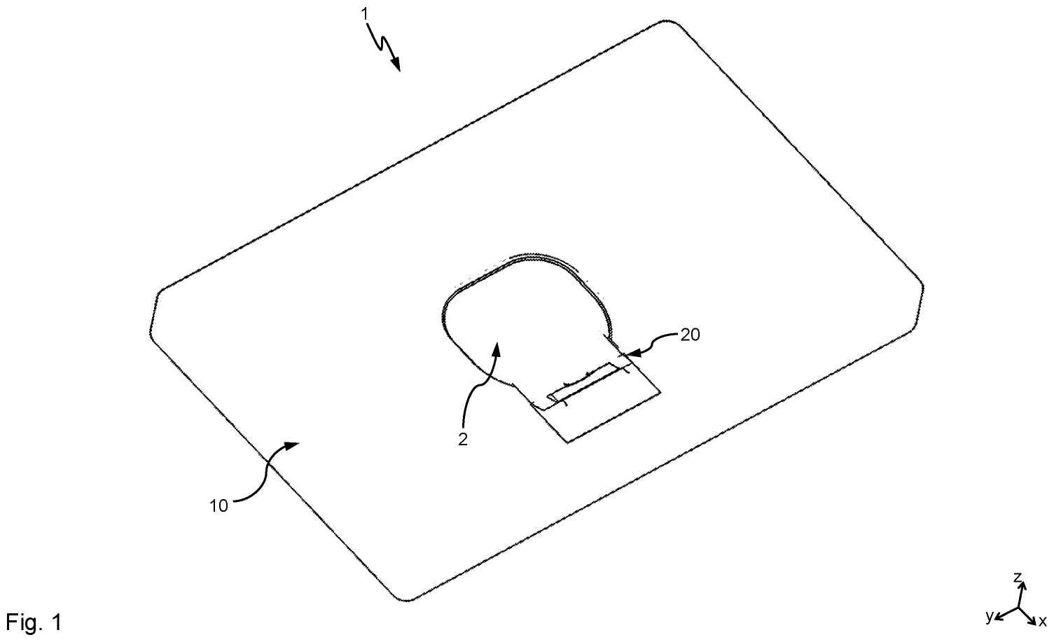

In FIG. 1, a vehicle unit 1 with a housing 10 is shown in a schematic perspective view from below. The vehicle unit 1 is configured to be arranged in an electric vehicle, wherein the vehicle unit 1 in this case is intended to be arranged in or on the underbody of the electric vehicle. However, the vehicle unit may, of course, also be arranged in other positions on the electric vehicle.

In this case, an electric vehicle is understood to be any vehicle which has a traction battery which may be externally charged—i.e. plugin hybrid vehicles as well as electric vehicles, for example.

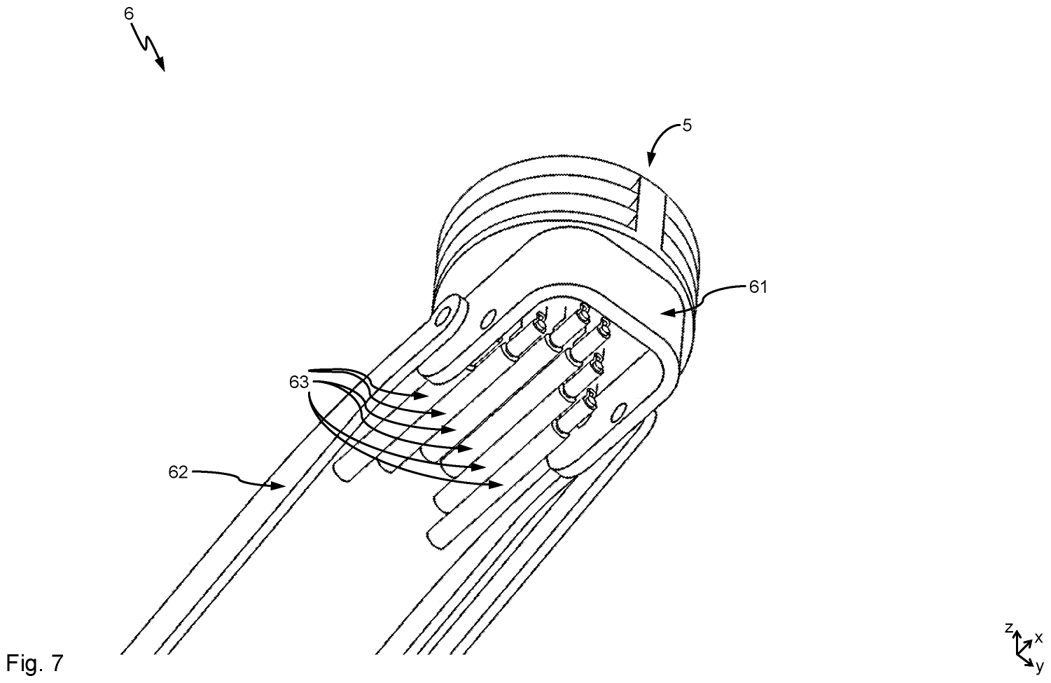

The external charging of a traction battery arranged in the electric vehicle is carried out accordingly via the vehicle unit 1. In order to enable the supply of charging current, the vehicle unit 1 must be connected to a floor unit 6 (indicated schematically in FIG. 7, for example).

The floor unit 6 is connected to the grid via corresponding conditioning devices, monitoring devices and/or charging controls, so that the correspondingly conditioned, monitored and controlled charging current may be delivered to the vehicle unit 1 via the floor unit 6 in order to execute the charging procedure of the traction battery arranged in the electric vehicle when contacting is established between the floor unit 6 and the vehicle unit 1. The means for providing, conditioning, monitoring and controlling a corresponding charging current are known per se.

The vehicle unit 1 and the floor unit 6 together form a charging device 100. In the embodiment shown, the vehicle unit 1 in this case provides the function of a charging socket, as it were, and the floor unit 6 provides the function of a plug. Mechanical and electrical contact between the floor unit 6 and the vehicle unit 1 may therefore be achieved.

The charging device 100 serves to establish automatic mechanical and electrical contact between the power supply and the traction battery in the electric vehicle so that the charging procedure may then be started in order to charge the traction battery in the electric vehicle.

In this case, by means of the charging device 100, it may be achieved that the entire mechanical and electrical contacting procedure, the charging procedure and, after completing the charging procedure, the separation of the mechanical and electrical contact proceed substantially automatically so that the user or driver of the electric vehicle does not have to intervene, or simply has to initiate the procedure, but does not have to perform any subsequent steps.

Instead, the user of the electric vehicle merely has to position the electric vehicle above a floor unit arranged on the floor of the parking space for the electric vehicle and park it there. The remaining steps of the mechanical and electrical contacting procedure and the charging procedure then take place without further activity on the part of the user.

In other words, automatic communication may take place between the electric vehicle to be charged and the charging device and, if a specified charge status of the electric vehicle is not met, for example, a charging procedure may be started automatically. However, it may also be provided that the user actively triggers the charging procedure, but at least further manual interaction between the user and the charging device is then unnecessary.

The floor unit then establishes physical contact with the electric vehicle via a contacting method (described below) in order to thus be able to provide a charging current for charging the traction battery of the electric vehicle. In particular, a contact head of the floor unit is connected to one or more contact arms of the vehicle unit, and electrical contact is thus established. Accordingly, by means of the charging device, particularly convenient operation of an electric vehicle provided with an electric motor and an associated traction battery may be enabled, in which the user, after parking the electric vehicle over the floor unit and possibly triggering the charging procedure, does not have to perform any further steps, since the charging device implements this automatically and independently.

To connect the traction battery to a power source, there is in particular no need for the user of the electric vehicle to have to manually guide a charging cable with a plug from a charging column or a wall box to the electric vehicle and to have to then carry out a corresponding plugging-in procedure; instead, this manual process may be omitted.

Equally, if contacting of the electric vehicle is still established, the proposed device is able to prevent a situation in which a user of the vehicle, who is already ready to drive off, then has to climb out of the vehicle again in order to release the inadvertently still established connection. Instead, by means of the proposed charging device, automatic independent disconnection may be achieved, which is carried out, for example, when the actual charging procedure has ended, i.e. the traction battery is completely full again, or is triggered, for example, by a user opening the electric vehicle or stepping inside the electric vehicle or switching on the “ignition” of the electric vehicle. In other words, a user also does not have to perform any active steps to disconnect the established contact with the charging device.

However, it may also be provided that the user specifies active disconnection via a corresponding disconnection command. In any case, the user does not have to perform any manual steps to disconnect the electric vehicle from the power supply.

The vehicle unit may be integrated in the underbody of the electric vehicle in order to be automatically contacted by a floor unit 6 integrated in the floor. It is likewise possible to fix the vehicle unit 1 on the side or in/on the roof of the electric vehicle, although the exemplary embodiments below are restricted to an assembly of the vehicle unit 1 on or in the underbody of the electric vehicle.

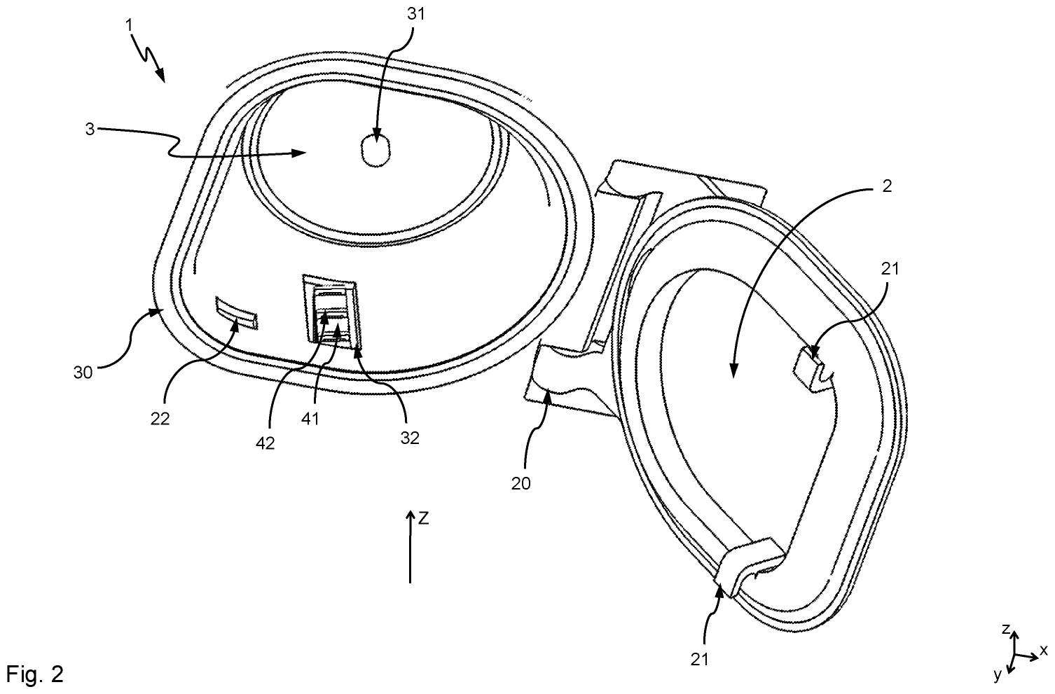

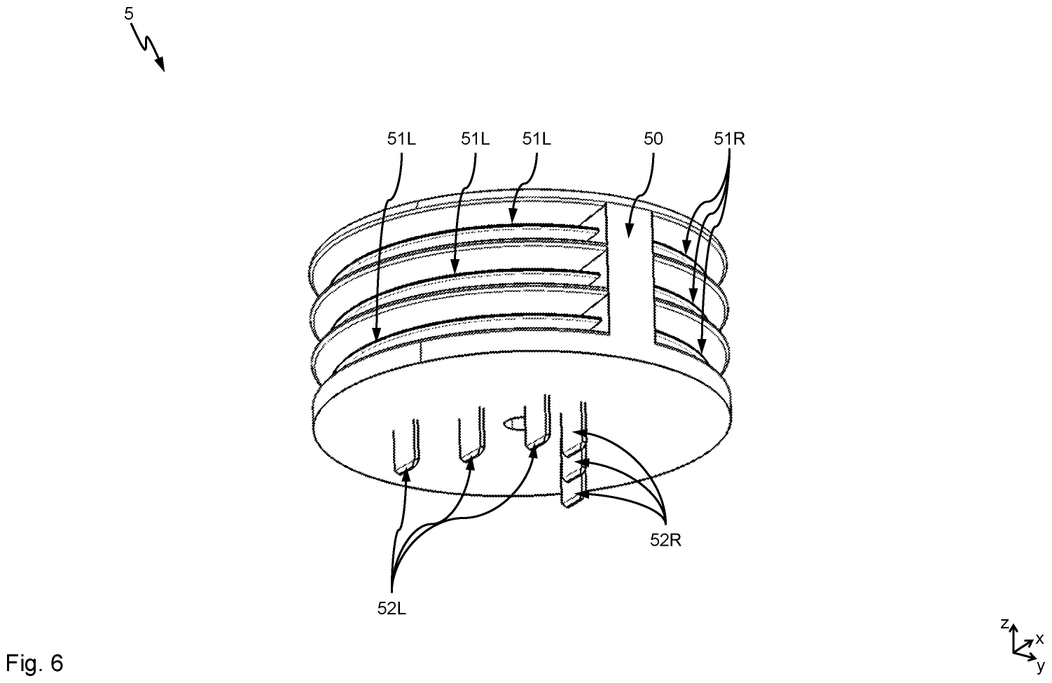

The vehicle unit 1 is illustrated in a view from below in FIG. 1, wherein a cover 2 for covering a receptacle (shown in FIG. 2), which is designed and configured for receiving a contact head 5 (shown by way of example in FIG. 6), is shown in a closed position.

The cover 2 is arranged such that it can pivot about a pivot axis 20 mounted near to the underbody so as to be able to move from an open position into a closed position. The cover 2 in various embodiments terminates the vehicle 1 in a planar manner. The vehicle unit 1 is in certain embodiments integrated in the underbody of the electric vehicle such that both the housing of the vehicle unit 1 and the cover 2 terminate flush with the rest of the underbody and an aerodynamically advantageous configuration may thus be achieved.

The opening and closing of the cover 2 could alternatively also be implemented by means of a four joint mechanism or by means of a displacement mechanism. However, the pivotable cover 2 enables a particularly simple design. An additional lock of the cover 2 is formed for this purpose, whereby a greater sealing contact pressure of a seal of the cover 2 may be achieved, as described in detail with reference to FIG. 2, amongst others.

In FIG. 2, the vehicle unit 1 of FIG. 1 is illustrated schematically with the cover 2 in an open position. In this case, the cover 2 is pivoted through approximately 90 degrees from a closed position into an open position. The pivotal movement takes place about the pivot axis 20, so that, in the open position, the cover 20 is orientated approximately perpendicularly to the underbody. A rotation through an angle which is greater than 90 degrees is likewise conceivable.

With an open position of the cover 2, the receptacle 3 is ready to receive a contact head 5. In this case, the receptacle 3 is designed and configured such that a contact head 5 may be inserted into the receptacle 3 in an insertion direction Z.

The receptacle 3 here is incorporated in the underbody of the electric vehicle in the form of a depression. The receptacle 3 is defined by a housing 30 and corresponds to the form of the contact head 5. A pin 31 for positioning the contact head 5 is provided in the receptacle 3 defined by the housing 30, wherein the pin 31 extends into the receptacle 3 in the insertion direction Z. When the contact head 5 is inserted into the receptacle 3, the pin 31 is inserted into a complementary depression in the contact head 5 in order to guide the contact head 5 laterally or radially and also to secure it in the inserted position.

The geometric design of the receptacle 3 depends, amongst other things, on the design of the contact head 5. In the present embodiments, the contact head 5 is designed to be cylindrical, so the receptacle is likewise designed to be substantially cylindrical. In this case, it is designed to be substantially geometrically complementary to the contact head 5, so that this latter may be easily inserted. In this case, the insertion direction Z coincides with the cylinder axis so that insertion of the contact head along the cylinder axis may be achieved.

The pin 31 therefore extends both in the insertion direction Z and along the cylinder axis of the receptacle 2 and the contact head 5 to be inserted.

In order to achieve lateral or radial guidance, the pin 31 may have a conical design.

Two cutouts 32 are positioned opposite one another on side walls of the housing 30. Guide elements 41 with contact elements 42 for contacting contacts 51 of the contact head 5 may pass through these cutouts 32. The form of the cutouts 32 is matched to the geometry of the guide elements 41 and the contact elements 42.

The housing 30 in FIG. 2 moreover has two opposing locking openings 22. These are provided for locking the cover 2 in a closed position by means of two locking hooks 21, arranged on the cover 2, interacting with securing elements 43 of the vehicle unit 1.

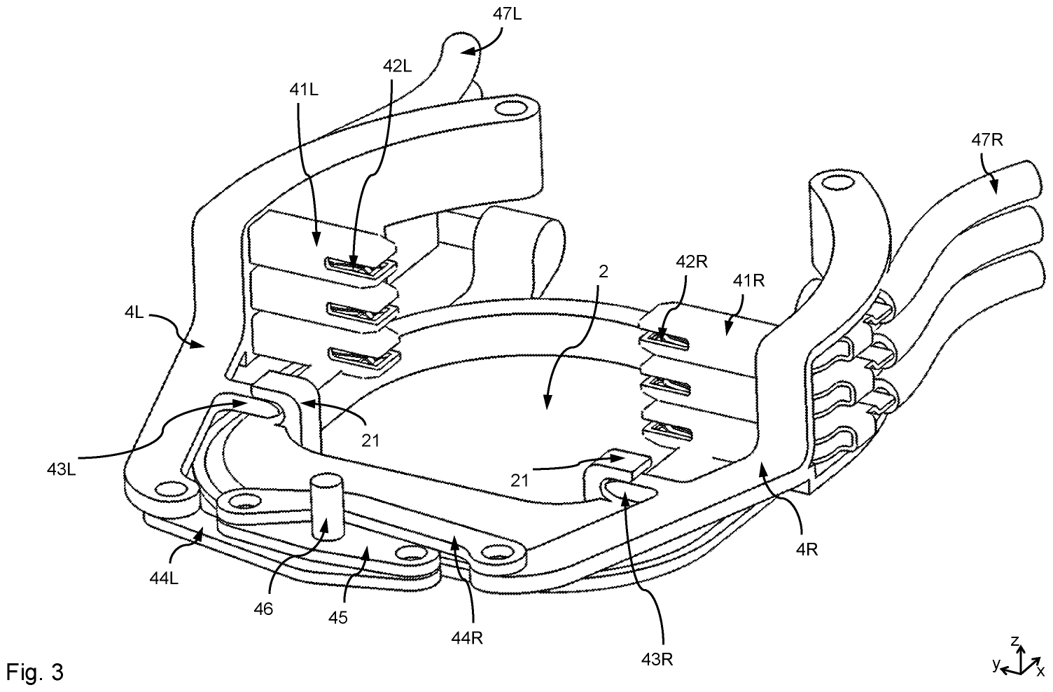

In FIG. 3, the vehicle unit 1 is illustrated schematically, and without the housing 30, from the inside. Two contact arms 4L, 4R are provided, each having three guide elements 41R, 41L. A respective contact element 42R, 42L for electrical contacting of the contact head 5 is arranged in in each guide element 41R, 41L. The contact elements 42R, 42L are conductively connected to the cables 47R, 47L. The cables 47R, 47L lead to a charging control inside the vehicle or to a connection device of the traction battery of the electric vehicle and therefore enable the charging of the traction battery when they are in communication with a power source via the contact head 5.

The two contact arms 4L, 4R are connected to one another by means of a kinematic system, which is designed as a rotational closure kinematic system here and which enables the guide elements 41R, 41L to move symmetrically into the receptacle 3 arranged between the contact arms 4L, 4R and out of it again. In this case, the guide elements 41R, 41L are moved into the receptacle 3 together with the contact elements 42R, 42L in a direction which is perpendicular to the insertion direction Z for the contact head 5.

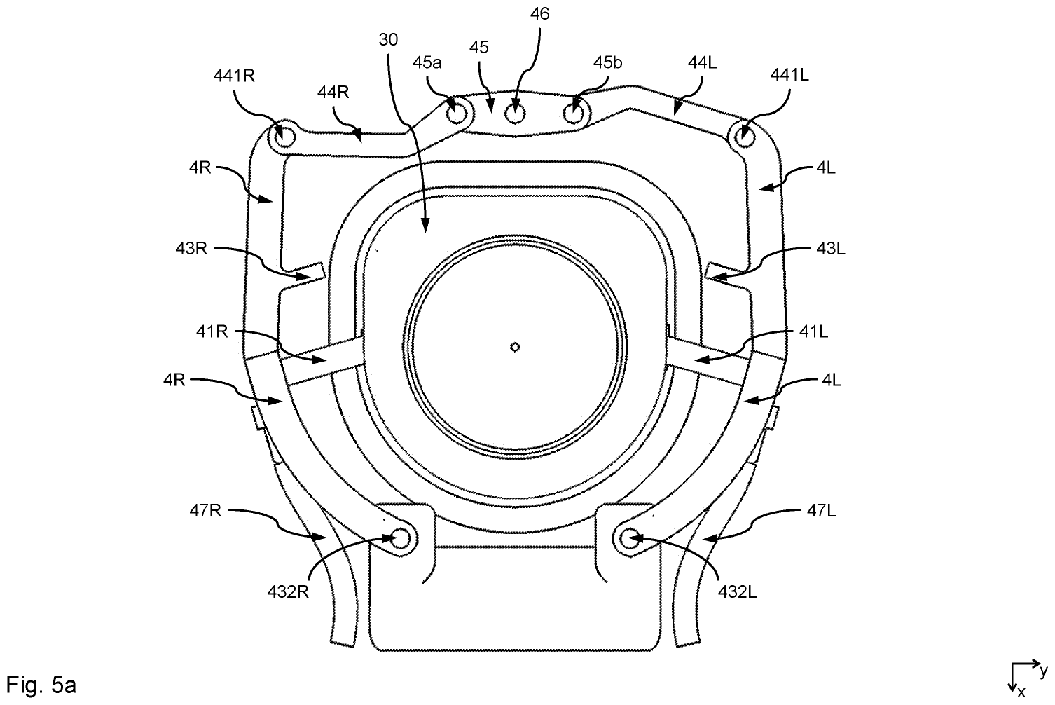

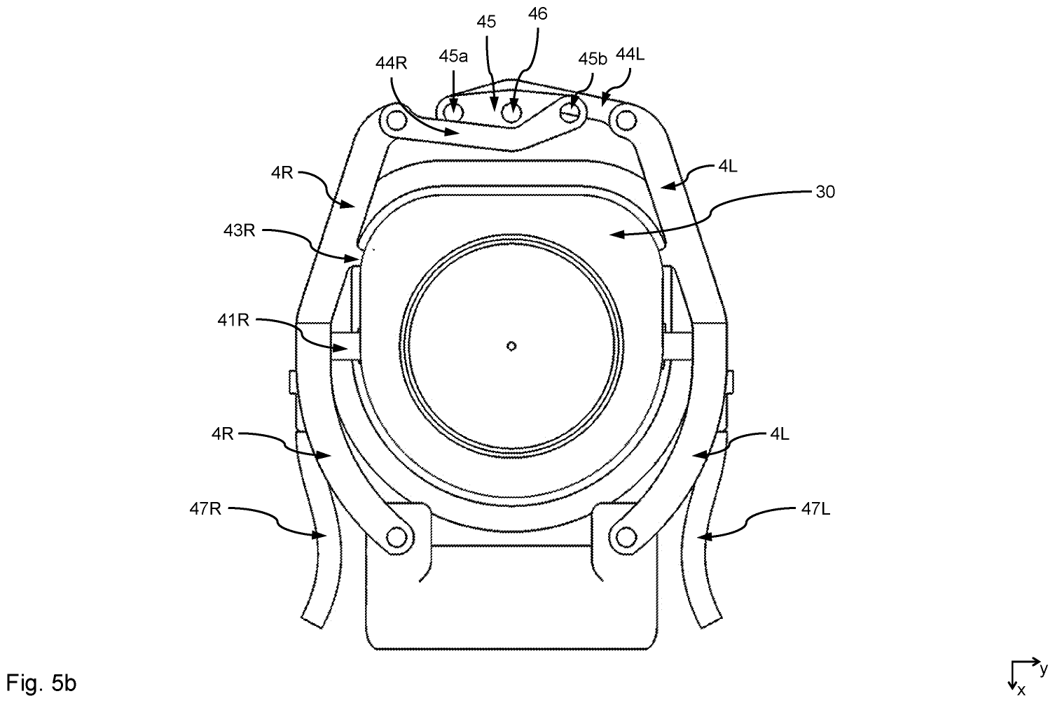

In this case, both contact arms 4R, 4L are rotatably connected to a connecting rod 45 via a coupling element 44R, 44L in each case. The connecting rod 45 may be pivoted through 180 degrees by means of a drive axle 46 in order to bring the contact arms 42R, 42L from a closed position into an open position and vice versa. In the closed position, the guide elements 42R, 42L are guided into the receptacle 3, as depicted in FIG. 3. In an open position, the guide elements 42R, 42L are located inside the vehicle unit 1 and outside the receptacle 3. A detailed description of the rotational closure kinematic mechanism follows below with reference to FIGS. 5a and 5b.

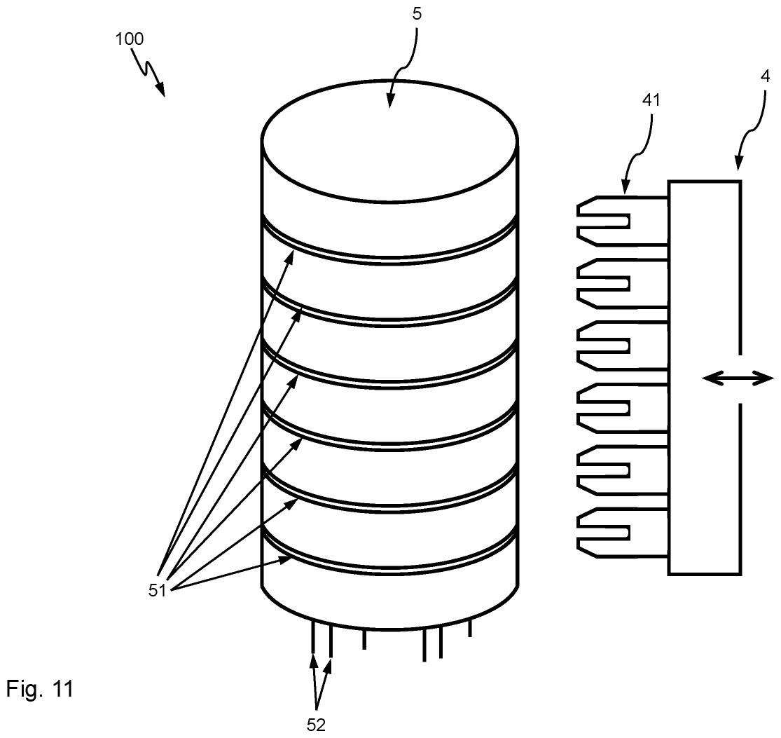

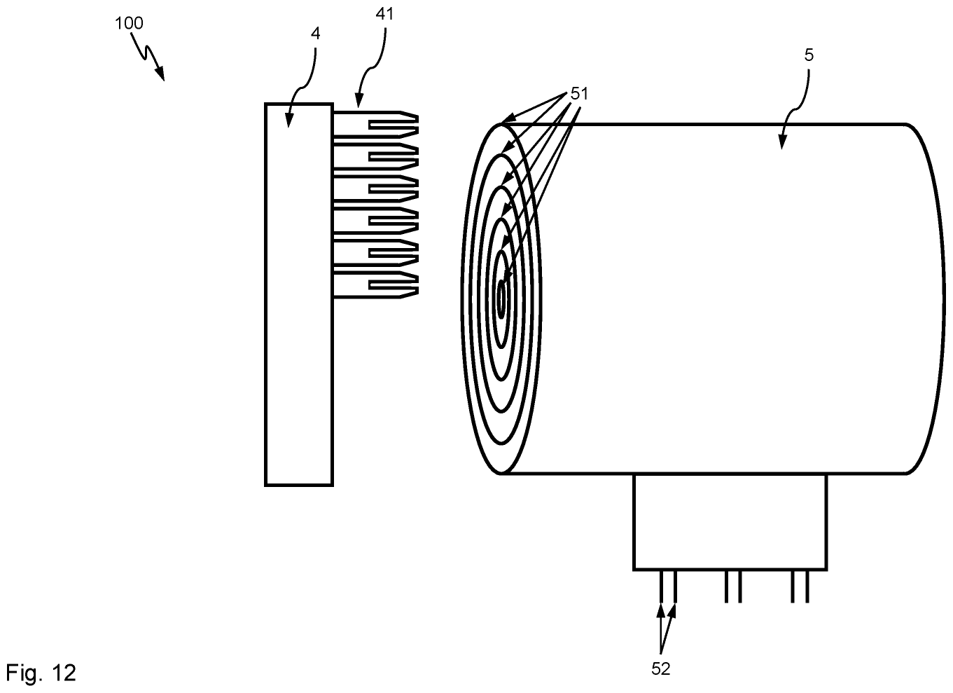

A symmetrical design of the three contact elements 42R, 42L on each contact arm 4L, 4R in each case matches the embodiment of the contact head of FIG. 6. Other exemplary embodiment options of a contact head 5 and the matching contact arms are explained in more detail with reference to FIGS. 11 and 12. In particular, depending on the configuration of the respective transmission properties, more or fewer than three contact elements may be provided.

In FIG. 3, the vehicle unit 1 is depicted in an inactive state, wherein the cover 2 closes the receptacle 3. In this case, the locking mechanism (already mentioned with respect to FIG. 2) of the cover 2 is clearly shown. The two locking hooks 2 fixed to the cover are located slightly above the locking openings 22. The locking openings 22 cannot be seen in FIG. 3, since the housing 30 surrounding the receptacle 3 is not depicted. However, it is possible to picture how the securing elements 43R, 43L, which are arranged on the contact arms 4R, 4L, penetrate through the locking openings 22 with the transition of the contact arms 4R, 4L from an open position into a closed position and therefore enter the locking hooks 21 and secure these together with the cover 2. By using a corresponding geometry of the locking hooks 21 and/or the securing elements 43, 43L—for example by creating a wedge-shaped configuration—a higher sealing contact pressure of the cover 2 on the rest of the housing may be achieved so that reliable sealing may be provided.

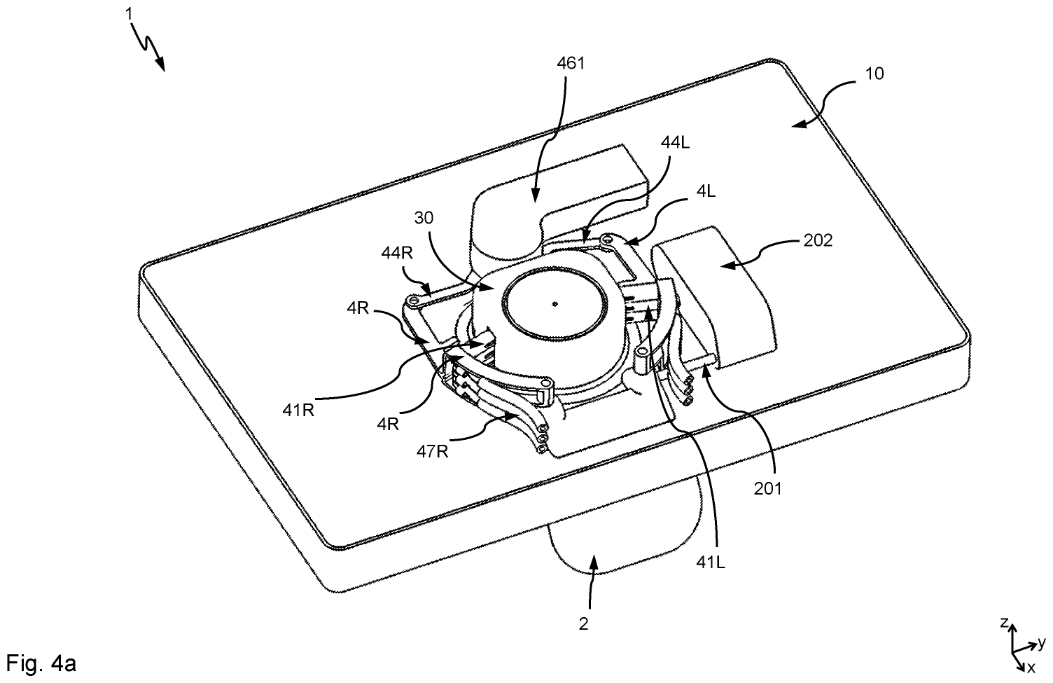

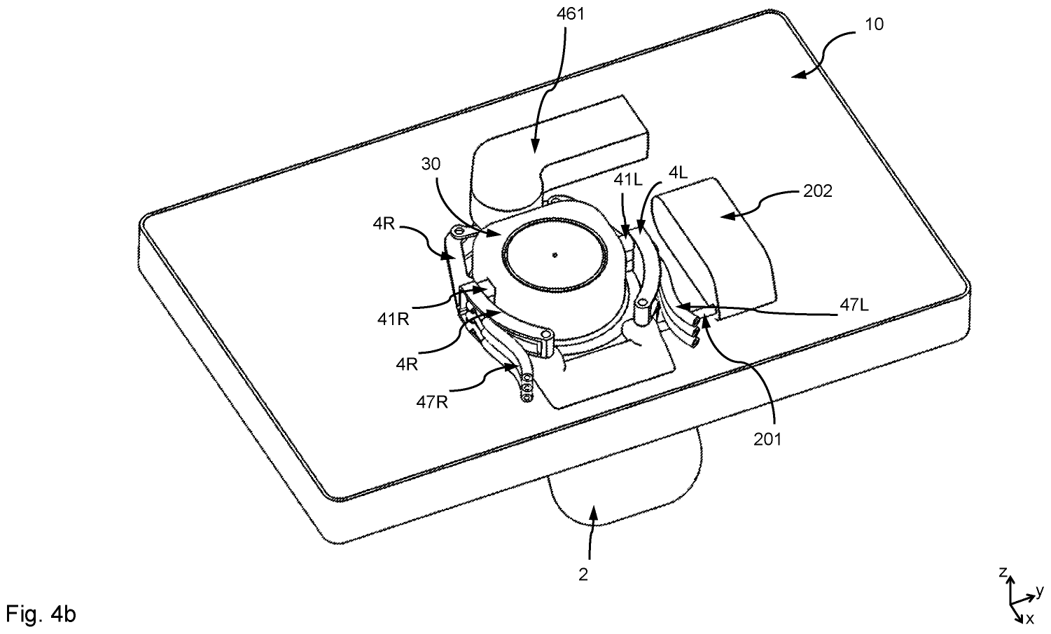

In FIGS. 4a and 4b, the vehicle unit 1 is illustrated schematically, and with the housing 30, from the inner side of the underbody. In this case, the contact arms 4R and 4L are illustrated in an open position in FIG. 4a and in a closed position in FIG. 4b. A housing of the drive mechanism 461, which moves the two contact arms 4R, 4L by means of the drive axle 46, can be seen in both figures. Likewise, a housing of the cover drive 202, with a drive axle 201 for pivoting the cover 2 about the pivot axis 20 from a closed position into an open position, and vice versa, can be seen in FIGS. 4a and 4b. The corresponding drives are in one or more embodiments designed as electric motors or servomotors.

In FIG. 4a, the contact arms 4R and 4L are shown in an open position, whereby the guide elements 41R, 41L are located entirely outside the receptacle 3 or outside the housing 30 and inside the underbody. The contact arms 4R and 4L can therefore not be seen from the outside, although the cover 2 is open. The receptacle 3 is therefore ready to receive a contact head 5.

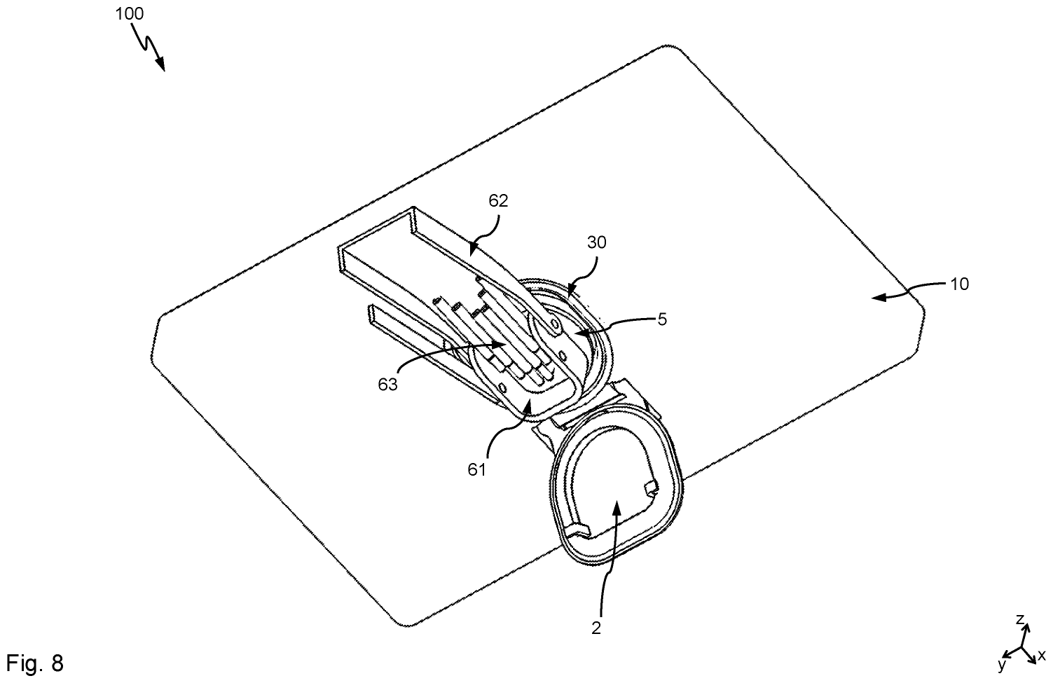

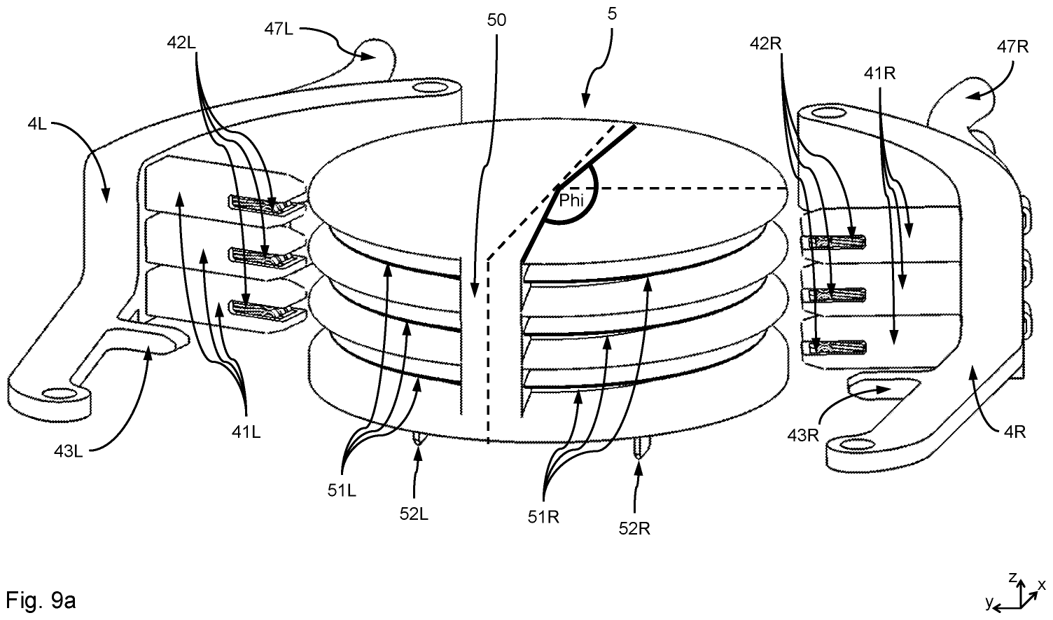

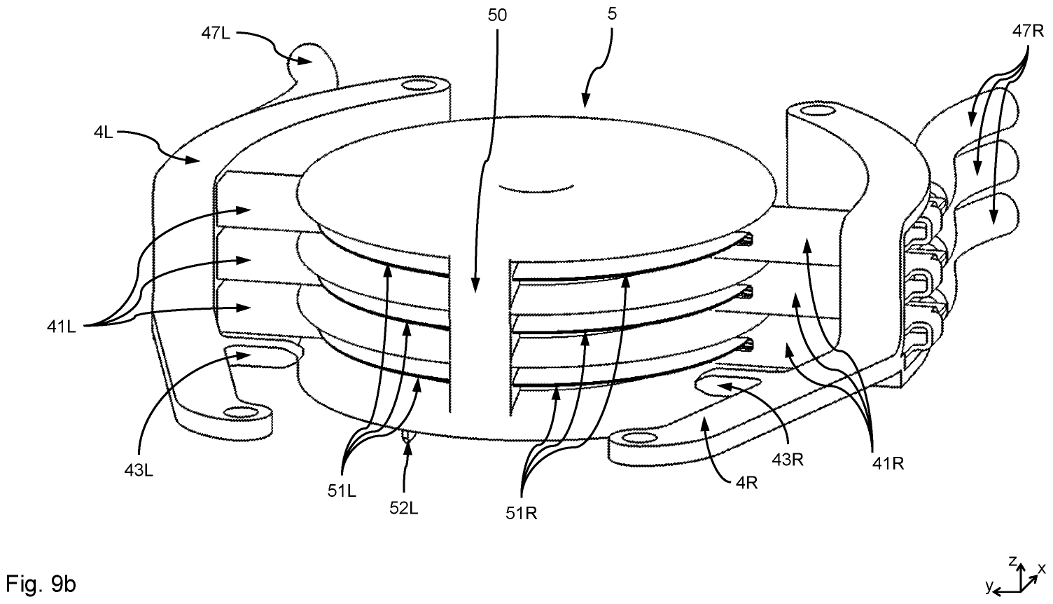

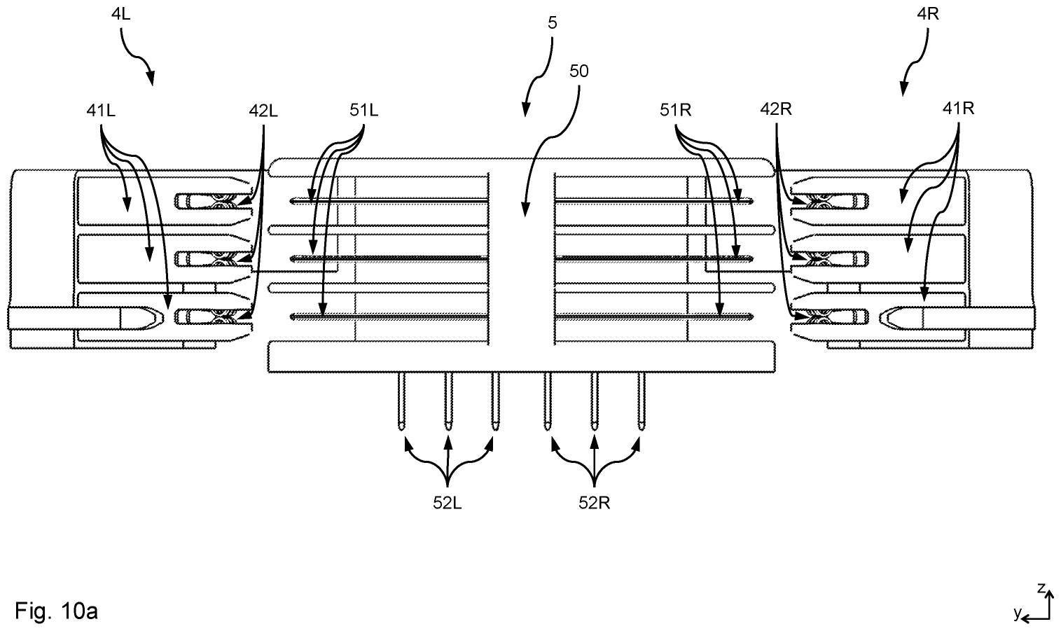

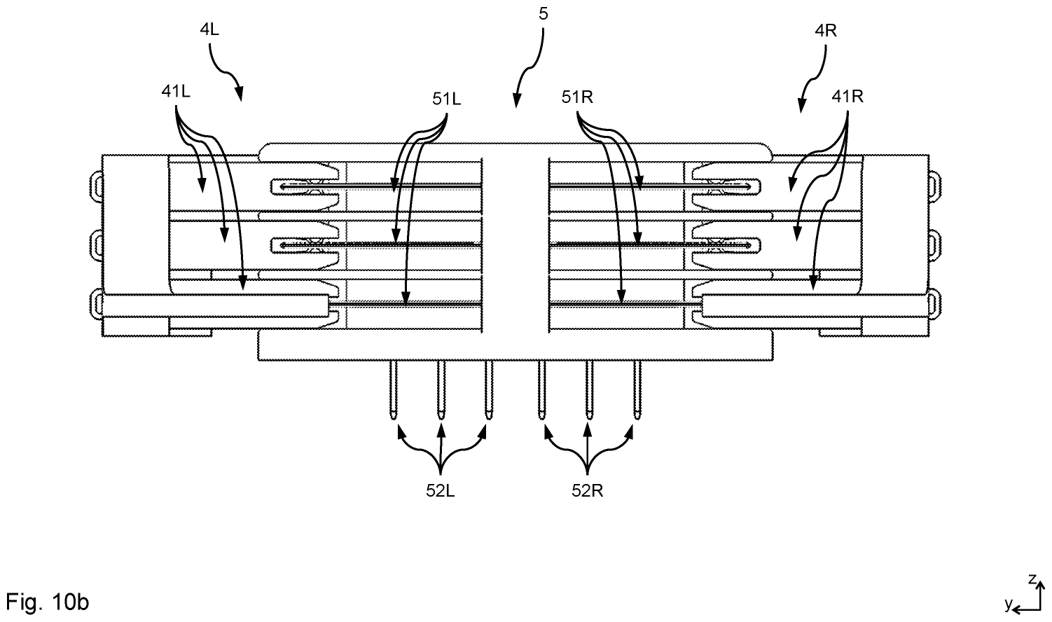

After the insertion of the contact head 5 into the receptacle 3, as will be explained with reference to FIG. 8, the contact arms 4R, 4L are moved from an open position into a closed position, wherein the guide elements 41R, 41L penetrate through the cutouts 32 in the housing 30, as depicted in FIG. 4b. In this case, an electrical connection is established between the contact elements 42R, 42L, mounted in the guide elements 41R, 41L, and the contacts 51R, 51L on the contact head 5, as described in detail below with reference to FIGS. 9a to 10b.

In FIGS. 5a and 5b, a plan view of the vehicle unit 1 of FIGS. 4a and 4b is likewise illustrated schematically from the inside. With the aid of the two FIGS. 5a and 5b, the mechanism of the rotational closure kinematic system is explained below.

In FIG. 5a, the contact arms 4R, 4L are in an open position according to FIG. 4a. The guide elements 41R, 41L are moved out of the receptacle 3 and are supported inside the vehicle unit. Each contact arm 4R, 4L is pivotably connected to the housing at one end by means of a pivot joint 423R, 432L.

At the other end, the contact arms are in communication with the coupling elements 44R, 44L by means of pivot joints 441R, 411L. The two coupling elements 44R and 44L are therefore rotatably coupled to contact arms 4R, 4L at one end and to the connecting rod 45 at the other end. The connecting rod 45 may be rotated via the drive axle 46. Upon an anti-clockwise rotation through 180 degrees about the drive axle 46, the coupling elements 44R, 44L are drawn together. Since the two contact arms 4R, 4L are connected to the coupling elements 44R, 44L, these are also symmetrically drawn together and are transferred from an open position according to FIG. 5a into a closed position according to FIG. 5b. After a successive clockwise rotation of the connecting rod 45, the contact arms 4R, 4L are transferred back into an open position.

The contact arms 4R, 4L are assembled in a plane parallel to the underbody or in a plane parallel to the insertion direction Z of the contact head 5. In other words, the pivot axes of the pivot joints 432R, 432L are aligned parallel to the insertion direction Z.

An assembly of the contact arms 4R, 4L in a plane parallel to the insertion direction Z of the contact head 5 is likewise conceivable, wherein the guide elements 41R, 41L are then mounted on the contact arms 4R, 4L such that, upon a movement of the contact arms 4R, 4L in the plane parallel to the insertion direction Z, the guide elements 41R, 41L may move into the receptacle 3, and out of it again, in the plane perpendicular to the insertion direction Z.

In FIG. 6, the contact head 5 is illustrated schematically from below. The contact head is designed to be cylindrical. Three contacts 51R, 51L are arranged one above another on each half of the contact head 5. The contacts 51R, 51L extend in each case in a circular segment Phi, which is smaller than 180 degrees, and is in some embodiments 150 degrees, wherein the housing 50 of the contact head 5 separates and electrically insulates the contacts 51R, 51L on the two halves from each other, in various embodiments via a circular segment of 30 degrees. The housing 50 likewise separates the contacts located above one another, 51R and 51L respectively, from each other. Each circular segment Phi must be smaller than 180 degrees so that the same circular segment cannot be contacted by both contact arms 4R, 4L.

In other words, the contacts 51R, 51L located one above another are arranged on the lateral surface of the cylindrical contact head 5.

The contacts 51L, 51R emerge underneath the contact head 5 in the form of conductor tracks 52L, 52R and are connected to the power source via a robot arm 62 or via another lifting device, as explained in more detail below with reference to FIG. 7, so that the charging of the traction battery of the electric vehicle may be carried out.

Alternative variants of the contact head 5 of FIG. 6 are conceivable. For example, instead of three contacts on two circular segments, two contacts may be mounted on three circular segments. The two circular segments may be different sizes. The number of circular segments with the contacts and the number of contacts mounted one above another can be varied as required so long as the are freely accessible from the side of the contact head so that they can be contacted by the vehicle unit 1 in a plane perpendicular to the insertion direction Z of the contact head 5.

In FIG. 7, the floor unit 6 comprising the contact head 5 and a robot arm 62 is illustrated schematically from below. The contact head 5 is arranged on a connecting element 61, wherein the conductor tracks 52R, 52L are conductively connected to charging cables 63. The charging cables 63 lead to the power source.

Instead of a robot arm, another lifting device which may insert the contact head 5 into the vehicle unit 1 may be provided. In this case, the contact head 5 is inserted into the receptacle 2 of the vehicle unit 1 in the insertion direction Z.

In the cylindrical design of the contact head 5 shown, the insertion direction Z coincides with the cylinder axis of the cylinder.

In FIG. 8, a charging device 100 comprising a floor unit 6 and a vehicle unit 1 is illustrated schematically from below. The cover 2 of the vehicle unit 1 is in an open position so that the access to the receptacle 3 for the contact head 5 is freely accessible. The contact head 5 fixed to the robot arm 62 has already been inserted into the receptacle 3 and may therefore by contacted by the vehicle unit 1.

The contacting between the contact head 5 and the contact arms 4R, 4L is explained in detail below with reference to FIGS. 9a, 9b and 10a, 10b.

In FIG. 9a, the contact arms 4R, 4L and the contact head 5 are illustrated schematically from above in a perspective view. The contact head 5 has been inserted into the receptacle 3, but the contact arms 4R, 4L are still in an open position. An electrical connection between the contact head 5 and contact arms 4R, 4L has not yet been established. The guide elements 41R, 41L with the contact elements 42R, 42L are at the same level as the contacts 51R, 52L of the contact head 5 after the insertion of the contact head 5 into the receptacle 3.

A precise rotation of the contact head 5 after the insertion of the contact head 5 into the receptacle 3 is not required since the contacts 51 extend in a circular segment of 150 degrees and the precise point along this contact segment at which the contacts 51R, 51L are contacted by the contact elements 42R, 42L is irrelevant. It is, however, assumed that a rough orientation of the contact head 5 is ensured beforehand, for example in that a general orientation is specified by the parking place for the electric vehicle.

By way of example, the orientation of the contact head 5 can vary by +/−75 degrees when the contacts 51R, 51L are provided in a circular segment of 150 degrees. A contact head 5, which enables a fully rotationally symmetrical connection, is described below with reference to FIG. 11.

A charging device 100 of FIG. 9a is shown in FIG. 9b, wherein the contact arms 4R, 4L are in a closed position. The guide elements 41R, 41L with the contact elements 42R, 42L are moved from the side of the contact head 5 and into the contact head 5, wherein the contact elements 42R, 42L are then electrically connected to the contacts 51R, 51L.

FIGS. 10a and 10b show a schematic side view of the charging device 100 according to FIGS. 9a and 9b. In FIG. 10a, the contact arms 4R, 4L are in an open position, i.e. an electrical connection with the contact head 5 is not yet established. The contact elements 42R, 42L are at the same level as the contacts 51R, 52L of the contact head 5 after the insertion of the contact head 5 into the receptacle 3. The contacts 51R, 51L are designed as conductor tracks. The contact elements 42R, 42L are designed as a spring clip. Upon the insertion of the guide elements 41R, 41L into the contact head 5, the contacts 51R, 51L, designed as conductor tracks, penetrate into the spring clips of the contact elements 42R, 42L and are held in a fixed manner by spring clips. A stable conductive connection between the floor unit 6 and the vehicle unit 1 is thereby ensured. Other forms of releasable connection between contacts of the floor unit and vehicle unit are also possible.

Finally, two further embodiments of a charging device 100 are illustrated schematically in FIGS. 11 and 12.

A contact head 5 and a contact arm 4 in a further embodiment are illustrated schematically in FIG. 11. The contact head 5 has six contacts 51 arranged in the form of a ring, one above another. A completely rotationally symmetrical contacting of the contact head 5 is thus possible. The vehicle unit 1 has only one contact arm 5 with six guide elements 41 arranged one above another. The movement of the contact arm 4 in the plane perpendicular to the insertion direction of the contact head 5 results in a movement of the guide elements 41 in and out of the contact head 5.

A contact head 5 in the form of a horizontal cylinder and a contact arm 4 in an alternative embodiment are illustrated schematically in FIG. 12. The contact head 5 has six coaxially extending contacts 51, which are openly accessible from the side. The vehicle unit 1 has a contact arm 1, likewise with six guide elements 41, which are arranged one above another and have contact elements 42. The contact arm 4 can be moved back and forth in the plane perpendicular to the insertion direction Z of the contact head in order to establish an electrical connection with the contacts on the contact head 5.

Where applicable, all individual features which are illustrated in the exemplary embodiments may be combined and/or interchanged with one another without deviating from the scope of the invention.

1-16. (canceled)

17. A vehicle unit for charging a battery of an electric vehicle, comprising:
a receptacle configured to receive a contact head of a floor unit, wherein the contact head is insertable in the receptacle in an insertion direction; and
contact elements configured to establish an electrical connection with contacts of the contact head, wherein the contact elements are configured to move in a plane perpendicular to the insertion direction to establish the electrical connection with the contact head.

18. The vehicle unit of claim 17, further comprising a contact arm, wherein a contact element is arranged on the contact arm, and the contact arm is configured such that a movement of the contact arm results in a movement of the contact element into or out of the receptacle in a plane perpendicular to the insertion direction of the contact head.

19. The vehicle unit of claim 18, wherein the contact arm comprises a first contact arm and a second contact arm, and a plurality of contact elements are arranged on each of the first contact arm and the second contact arm.

20. The vehicle unit of claim 19, wherein the first contact arm and the second contact arm are connected to one another via a kinematic system, and the kinematic system enables the plurality of contact elements to move into and out of the receptacle.

21. The vehicle unit of claim 20, wherein the kinematic system comprises a rotational closure kinematic system.

22. The vehicle unit of claim 17, wherein the receptacle is defined by a housing having a cutout through which the contact elements are configured to pass to establish the electrical connection with the contacts of the contact head.

23. The vehicle unit of claim 22, further comprising a cover configured to cover the cutout.

24. The vehicle unit of claim 17, further comprising a centering device, wherein the centering device is placeable in the receptacle to position the contact head, and the centering device extends in the insertion direction.

25. The vehicle unit of claim 24, wherein the centering device comprises a pin.

26. The vehicle unit of claim 17, wherein the receptacle is substantially rotationally symmetrical and an axis of symmetry of the receptacle extends in the insertion direction.

27. The vehicle unit of claim 26, wherein the receptacle is cylindrical.

28. The vehicle unit of claim 17, further comprising a cover configured to cover the receptacle, wherein the cover comprises a flap with a pivot axis.

29. The vehicle unit of claim 28, wherein the cover comprises a hook, and when the cover is closed, the hook is configured to be secured by a kinematic system via securing elements arranged on a contact arm of the vehicle unit.

30. A floor unit comprising:
a contact head configured to charge a battery of an electric vehicle arranged on a lifting device, wherein the contact head is configured to be inserted into a receptacle of a vehicle unit in an insertion direction, the contact head comprises contacts configured to establish an electrical connection with contact elements of the vehicle unit, and the contacts are configured to be contacted in a plane perpendicular to the insertion direction.

31. The floor unit of claim 30, wherein the contact head is rotationally symmetrical, an axis of symmetry of the contact head extends in the insertion direction, and the contacts are arranged in grooves in a lateral surface of the rotationally symmetrical contact head.

32. The floor unit of claim 31, wherein the contact head is cylindrical.

33. The floor unit of claim 31, wherein the contacts are arranged one above another in the insertion direction in the lateral surface of the rotationally symmetrical contact head, and three contacts or six contacts are arranged in the form of a ring, one above another.

34. The floor unit of claim 31, wherein the contacts extend substantially in only half of the lateral surface of the rotationally symmetrical contact head, and the contacts each extend in a circular segment that is smaller than 180 degrees and greater than 90 degrees.

35. A charging device for charging a battery of an electric vehicle comprising:
the vehicle unit of claim 17; and
the floor unit comprising the contact head.

36. A method for automatically charging an electric vehicle, comprising:
providing a vehicle unit that is mountable in an underbody of the electric vehicle, wherein the vehicle unit comprises a receptacle and movable contact elements;
inserting a contact head of a floor unit into the receptacle of the vehicle unit in an insertion direction; and
moving the movable contact elements in a plane perpendicular to the insertion direction to establish an electrical connection between the contact head and the vehicle unit.
